(19) United States
(12) Patent Application Publication
(10) Pub. No.: US 2010/0259013 A1
(43) Pub. Date: Oct. 14, 2010

(54) ABRADABLE LABYRINTH SEAL FOR A FLUID-FLOW MACHINE

(75) Inventor: Karl SCHREIBER, Am Mellensee (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/729,953

(22) Filed: Mar. 23, 2010

(30) Foreign Application Priority Data
Apr. 9, 2009 (DE) 10 2009 016 803.6

(51) Int. Cl. F16J 15/447; F01D 11/02

(52) U.S. Cl. 277/415

(57) ABSTRACT

An abradable labyrinth seal for a fluid-flow machine seals a sealing gap between a stationary carrier (9) provided with an abradable lining (10) of porous material formed by hollow bodies (11) and a rotary component (4) provided with sealing fins (8) oriented towards the abradable lining. In a preferred embodiment, elongated hollow bodies (11) conforming in shape and size are linearly arranged as an ordered cellular structure side by side and one above the other in x, y and z directions and are interfacially or fully interfacially connected to each other with or without open pores (12). The hollow bodies (11) are arranged such that the tips of the sealing fins (8) are approximately centrally oriented to the hollow bodies (11).

This application claims priority to German Patent Application DE102009016803.6 filed Apr. 9, 2009, the entirety of which is incorporated by reference herein.

This invention relates to an abradable labyrinth seal for a fluid-flow machine for sealing a sealing gap between a stationary carrier provided with an abradable lining of porous material formed by hollow bodies and a rotary component provided with sealing fins oriented towards the abradable lining, in particular for hot gas sealing in the area of the turbine of a gas-turbine engine.

On machines with flowing fluids, it is often necessary to seal gaps between moving and static components against the flowing medium. The quality of the seals used for this purpose considerably influences the efficiency of these machines. For sealing the gap, as is generally known, labyrinth seals are used which include several, circumferential sealing strips or sealing fins arranged at a certain distance to each other and extending transversely to the flow direction. In order to minimize the radial gap between the rotary and the stationary component to improve the efficiency and performance of fluid-flow machines, it is possible to let the tips of the sealing strips rub against an abradable lining. However, the abradable seals shall not only prevent the respective stage of the fluid-flow machine from being flown over, but also thermally insulate the casing structure, for example the hot-gas conveying wall sections of a turbine stage, or control the heat flux into the wall sections in such a manner that the thermal expansion of the stationary components or the casing expansion, respectively, corresponds to the thermal expansion of the rotary components, i.e. the rotor disks and blades, thereby ensuring a minimum gap dimension in dependence of the operating conditions or the hot-gas temperatures, respectively.

As is generally known, honeycomb structures filled with a thermal insulating material are used as rub-in or abradable lining, respectively, which, while having good rubbing or wear characteristics, do not satisfy the respective requirements on the thermal insulation of the stationary component with regard to obtaining a constantly small gap width. Furthermore, smearing may occur in the rubbing area between the sealing fins and the honeycomb structure which may result in overheating and, finally, cracking of the sealing fins.

Specification EP 1013890 B1 describes an abradable labyrinth seal whose abradable lining completely consists of a foamed, metallic, corrosion-resistant high-temperature alloy, i.e. a metal foam with closed-pore structure in which thin walls enclose between them a plurality of cavities. Alternatively, it has also been proposed to produce such a structure from pre-made metallic hollow spheres. The foam structure used as abradable lining has high heat-insulating effect. However, due to the irregularity of the foam structure, material accumulations with resultant strong heating as well as chipping of the brittle metal foam structure may occur here as well. Furthermore, this abradable structure does not allow the thermal insulation to be adequately influenceable in accordance with the varying temperature conditions in the fluid-flow machine, for example the different hot-gas temperatures in the areas of the high-pressure turbine and the low-pressure turbine of a gas-turbine engine.

In a broad aspect, the present invention provides an abradable labyrinth seal with thermal insulation adapted to the respective operational situation and reliable sealing effect as well as a long service life.

On the basis of an abradable labyrinth seal for a fluid-flow machine for sealing a sealing gap between a stationary carrier provided with an abradable lining of porous material formed by hollow bodies and a rotary component provided with sealing fins oriented towards the abradable lining, the present invention, in its essence, provides that hollow bodies conforming in shape and size are exactly linearly arranged side by side and one above the other in x, y and z direction and are interfacially connected and form an ordered, open or closed-pore cellular structure, with the hollow bodies being arranged and orientated such that the tips of the sealing fins approximately centrally meet the hollow bodies. Since the hollow bodies are arranged such that the tips of the sealing fins essentially centrally contact the hollow bodies, material accumulations resulting in excessive heating and consequential cracking of the sealing fins will not occur. Thus, a reliable sealing effect, safe operation and long service life of the fluid-flow machine are ensured. Depending on the required thermal insulation relative to the carrier component, the degree of open-porosity is variable and may also be zero where maximum heat insulation is required.

The abradable lining is produced by sintering green spheres including a core coated with sinterable metal powder under temperature and pressure, with the core material outgassing in the process and the remaining hollow spheres being interfacially joined and formed to produce a longitudinal elongation in flow direction. Thus, it is more easily possible that the sealing strips essentially centrally meet the hollow bodies and not the material accumulations of the hollow-body structure. However, the hollow bodies can also be designed as radially or tangentially elongating elements.

The shape of the hollow bodies and the amount of interfacial contact therebetween as well as the amount and proportion of open pores is controlled by the amount and type of the pressure applied on the linearly arranged green-sphere sinter material.

In a further development of the present invention, layers of relatively small hollow bodies located in the existing interspaces can be arranged between the individual hollow-body layers to provide for the reduction of open porosity or the formation of a closed-pore abradable lining.

The present invention is more fully described in light of the accompanying drawing showing a preferred embodiment. In the drawing,

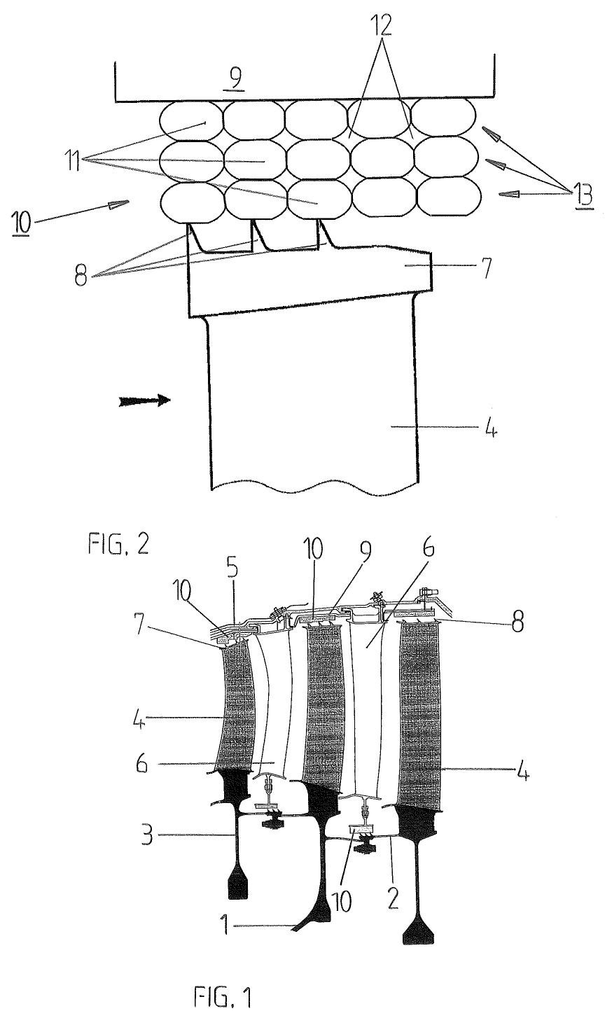

FIG. 1 shows a portion of the low-pressure turbine of a gas-turbine engine sealed with abradable labyrinth seals, and

FIG. 2 is a schematic representation of an abradable labyrinth seal formed by an open-pore abradable lining and sealing fins.

In FIG. 1, the partial illustration of the low-pressure turbine of a gas-turbine engine shows three rotor disks 3 to which turbines blades 4 (rotary component) are attached and which are connected to the low-pressure turbine shaft via a rotor arm 1 and to each other via connecting flanges 2. Arranged between the turbine blades 4 are stator vanes 6 (stationary component) which are attached to the turbine casing 5. Shrouds 7 arranged at the tips of the turbine blades 4 each form three sealing fins 8 extending circumferentially and transversely to the direction of flow. Such sealing fins 8 are also provided on the connecting flanges 2 between the rotor disks 3. Attached to a carrier 9 arranged on the inner side of the turbine casing 5 opposite the sealing fins 8 of the shrouds 7 is an abradable lining 10, for example by brazing. Such a carrier 9 with an abradable lining 10 is also provided at the shrouds 7 connected to the tips of the stator vanes 6. The abradable lining 10 is designed such that, in the case of contact with the sealing fins 8, the material of the abradable lining 10 is worn off, i.e. the tips of the sealing fins 8 can penetrate into the abradable lining, thus enabling a very narrow sealing gap and a high sealing effect and, accordingly, a high efficiency of the fluid-flow machine to be obtained.

The abradable lining 10 is a defined, ordered cellular structure of hollow bodies 11 made of high-temperature resistant, sintered material and essentially conforming in shape and size and connected to each other by sintering under pressure and being exactly linearly arranged to each other in x, y and z direction, forming here three hollow-body layers 13 lying exactly one above the other. An essential feature of the abradable labyrinth seal is that the hollow bodies 11 of the abradable lining 10 are positioned such in relation to the sealing fins 8 that the tips of the latter are essentially centrally orientated to the hollow bodies 11 of the abradable lining 10. Thus, accumulation of material during rubbing of the abradable lining 10 and, in consequence thereof, severe heating or even cracking of the sealing fins 8 is precluded.

The ordered cellular structure for the abradable lining 10 is produced by sintering of styrofoam spheres coated with a sinterable metal powder. In a preferred method, the green spheres, yet unsintered and coated with the sintering material to the required wall thickness, are, for the production of the hollow sphere structure (abradable lining 10), placed in a mold and sintered therein by application of pressure and temperature and simultaneously joined to each other by sintering. According to the pressure force and pressure direction applied, the hollow spheres produced during sintering are flattened at the mating faces with the mold wall or the adjacent hollow spheres and, as shown in FIG. 2, formed in the present embodiment to (elongated) hollow bodies 11 being flatter at the top and bottom surfaces than at the side faces and interfacially joining each other. Owing to the elongated shape, also relatively small hollow bodies 11 can be brought into a preferred central position relative to the tips of the sealing fins 8, thereby preventing material accumulations during rubbing and the associated high temperatures from occurring. Depending on the amount and direction of the pressure forces applied during sintering, the ordered cellular structure of the abradable lining 10 can, as shown in FIG. 2, be open-pore, i.e. with outwardly open pores 12, or also closed-pore. Also, the size of the open-pore area, and the thus possible hot-gas flow, or the degree of thermal insulation, relative to the stationary component (turbine casing), is variable during the production of the hollow-body structure. A closed-pore or largely closed-pore design provides for high thermal insulation, which is required in particular in the area of the high-pressure turbine, and, consequently, a small gap dimension between the turbine blades and the turbine casing and, finally, low performance losses. A certain open-porosity can, as shown in FIG. 2, be provided in the area of the low-pressure turbine because of the relatively low temperatures to enable the gap width to be influenced. If applicable, cooling air can be specifically introduced through an open-pore structure to reduce the hot-gas influence.

### LIST OF REFERENCE NUMERALS

1 Rotor arm
2 Connecting flange
3 Rotor disk (rotary component)
4 Turbine blade (rotary component)
5 Turbine casing
6 Stator vane (stationary component)
7 Shroud
8 Sealing fin
9 Carrier (stationary component)
10 Abradable lining (hollow-body structure)
11 Hollow body
12 Open pores
13 Hollow-body layer

What is claimed is:

1. An abradable labyrinth seal for a fluid-flow machine for sealing a sealing gap between a stationary carrier and a rotary component, comprising:
an abradable lining attached to the stationary carrier, the abradable lining of porous material formed by a plurality of hollow bodies;
at least one sealing fin attached to the rotary component and oriented towards the abradable lining;
wherein the hollow bodies conform in shape and size and are linearly arranged as an ordered cellular structure side by side and one above another in x, y and z directions and are interfacially connected to each other, with the hollow bodies being arranged such that a tip of the sealing fins is approximately centrally oriented to at least one of the hollow bodies.

2. The abradable labyrinth seal of claim 1, wherein the abradable lining is constructed of sintered green spheres coated with sinterable metal powder and aligned to each other in an ordered structure.

3. The abradable labyrinth seal of claim 2, wherein the shape of the hollow bodies and an amount of interfacial contact therebetween, as well as an amount and proportion of open pores, are variable in accordance with a pressure applied on the green sphere arrangement in the sintering process.

4. The abradable labyrinth seal of claim 3, wherein the hollow bodies are elongated in an axial direction of the fluid-flow machine.

5. The abradable labyrinth seal of claim 3, wherein the hollow bodies are elongated in a radial direction.

6. The abradable labyrinth seal of claim 3, wherein the hollow bodies are elongated in a circumferential direction of the fluid-flow machine.

7. The abradable labyrinth seal of claim 1, wherein an amount of open pores in the abradable lining is set as a function of a required heat insulation relative to the carrier.

8. The abradable labyrinth seal of claim 1, and further comprising relatively small sintered hollow bodies arranged in interspaces existing between individual hollow body layers to form a closed-pore structure.

9. The abradable labyrinth seal of claim 1, wherein the abradable labyrinth seal is a hot gas seal in a turbine area of a gas-turbine engine.

10. The abradable labyrinth seal of claim 1, wherein the abradable lining has an open pore structure.

11. The abradable labyrinth seal of claim 1, wherein the abradable lining has a closed pore structure.
